(19) United States
(12) Patent Application Publication
(10) Pub. No.: US 2010/0238195 A1
(43) Pub. Date: Sep. 23, 2010

(54) Systems and Methods for Reviewing Digital Pen Data

(75) Inventors: David McGee, Bainbridge Island, WA (US); Philipp Schmid, Mercer Island, WA (US); Paulo Barthelmess, Fremont, CA (US)

Correspondence Address: BLACK LOWE & GRAHAM, PLLC, 701 FIFTH AVENUE, SUITE 4800, SEATTLE, WA, 98104, US

(73) Assignee: ADAPX INC., Seattle, WA (US)

(21) Appl. No.: 12/712,080

(22) Filed: Feb. 24, 2010

Related U.S. Application Data
(60) Provisional application No. 61/155,012, filed on Feb. 24, 2009.
(60) Provisional application No. 61/170,540, filed on Apr. 17, 2009.

(51) Int. Cl. G09G 5/00; G06T 11/00

(52) U.S. Cl. 345/634; 345/467

(57) ABSTRACT

Systems and methods for error checking an entry converted from digital ink to text are disclosed herein. A method for reviewing digital pen data comprising importing handwritten ink made with a digital pen into an input region of a form. The handwritten ink is interpreted to produce a typographical symbol in the input region. The interpretation producing the typographical symbol is assigned a confidence factor, the confidence factor defining the likelihood that the conversion was correct. Input areas are highlighted if they have a confidence factor below a threshold value. Further, a view of the handwritten ink relative to the typographical symbol is changed by making one of the ink or the symbol more viewably prominent while simultaneously making the other less viewably prominent.

### PRIORITY CLAIM

This application claims priority to U.S. Provisional Patent Application No. 61/155,012 filed on Feb. 24, 2009 and also claims priority to U.S. Provisional Patent Application No. 61/170,540 filed on Apr. 17, 2009, the subject matter of each is incorporated herein by reference in its entirety.

### BACKGROUND OF THE INVENTION

Conventional digital paper systems, which include a digital writing surface and a digital pen device, have become very popular. The digital pen device determines its location in real time on the digital writing surface, which may include a visible or non-visible digital pattern. The writing surface may take the form of a digital tablet or digital paper, for example digital paper made by the Anoto Group AB and having an ANOTO® pattern. Various types of conventional digital pen devices include, but are not limited to, the MAXELL® digital pen, the NOKIA® digital pen, the LEAPFROG FLYFUSION® digital pen, LIVSCRIBE® Pulsepen, the ANOTO® digital pen, and the LOGITECH® digital pen. Besides knowledge of placement location, some digital paper systems also maintain records of information like pressure or time as well as various “state” values such as color or width.

The digital pattern enables the digital pen to interact with printed content, text, lines, images, etc. which may take the form of spreadsheets, maps, AutoCAD layouts, etc. The printed content is overlaid on top of, or otherwise applied to the digital pattern, which allows the digital pen to “see through” the printed content and capture its exact position from the digital pattern.

### BRIEF DESCRIPTION OF THE DRAWINGS

Preferred and alternative examples of the present invention are described in detail below with reference to the following drawings:

FIG. 1 is a block diagram showing a computer, various computer peripherals, and various communication means for the computer according to an embodiment of the invention;

FIG. 2 is a schematic view of a system for error checking a document converted from digital ink to text according to an embodiment of the present invention;

FIG. 3 is a schematic view of a system for error checking a document converted from digital ink to text according to an embodiment of the present invention;

FIG. 4 is a flowchart showing a method for error checking a document converted from digital ink to text according to an embodiment of the present invention;

FIG. 5 is a top plan view of a form showing error checking according to an embodiment of the present invention;

FIGS. 6A and 6B show a top plan view of a form showing error checking of a digital document by contextually comparing handwritten digital ink with typographical text according to an embodiment of the present invention;

FIG. 7 is a top plan view of a form showing display interpretation options for the handwritten ink in a menu operably coupled to an input region according to an embodiment of the present invention; and

FIG. 8 is a top plan view of a form having both ink and text stored in the portable document format according to an embodiment of the present invention.

### DETAILED DESCRIPTION OF THE PREFERRED EMBODIMENT

In the following description, certain specific details are set forth in order to provide a thorough understanding of various embodiments of the invention. However, one skilled in the art will understand that the invention may be practiced without these details or with various combinations of these details. In other instances, well-known systems and methods associated with, but not necessarily limited to, converting digital ink into text, digital paper systems, digital pens and methods for operating the same may not be shown or described in detail to avoid unnecessarily obscuring descriptions of the embodiments of the invention. For purposes of the description herein, the phrase “digital ink” refers generally to the handmade strokes made and optionally recorded by a digital pen.

The present invention is generally directed to systems and methods for reviewing digital pen data. For example, error checking digital ink to text conversions. By way of example, one such reviewing method includes using a confidence factor, output from a digital ink to text conversion program, to determine if a predetermined threshold value has been obtained. The threshold value may be ore-set or set by a user to correspond to a level of confidence considered acceptable during ink to text conversion. If the confidence factor obtained during ink conversion is lower than the threshold value, then a visible indicator is displayed to a user showing an area of potential error. The visual indicator alerts the user to a likely incorrect ink to text conversion. In another embodiment, text and ink are displayed simultaneously to aid in a user's conceptual review of the ink to text conversion.

Generally, when using digital ink and digital paper, handwritten strokes made by a digital pen are converted automatically into text with a handwriting recognition program. While there have been significant improvements in the handwriting-to-text conversions, it may still be prudent to review the converted digital pen data. However, checking every term may be time consuming, costly, and relatively unwielding when applied to large scale reviews of multiple forms or documents, which may be from multiple sources.

An embodiment of the present invention relates generally to error checking a document converted from digital ink to text. To focus a review and check only those terms that are most likely incorrect, the reviewing system “flags” text conversions having a confidence factor below a threshold value. By flagging the text, a user may quickly and visibly drawn to only those text conversions that are most likely to be incorrect.

Another type of reviewing system provides for error checking a digital form by contextually comparing handwritten digital ink with typographical text. When a user writes on a digital form in a region or cell using a digital pen, that handwriting is interpreted by the system in preparation for conversion to text. The handwritten ink is converted to produce a typographical symbol, which may take the form of one or more alphanumeric characters, symbols, and/or shapes. Both the handwritten ink and the typographical symbols are co-located, or optionally overlaid, when displayed to a user in the assigned text area of the digital document. The user is then able to selectively determine which of the ink or text is more visually prominent.

In a digital ink-to-text conversion process, the conversion of a particular term or marking is called a recognition event. A confidence factor is assigned to each recognition event, where the factor may be defined to be between zero “0” and one “1.” Alternatively, the confidence factor may be any normalized value. The confidence factor indicates a confidence level or correctness level of the text conversion. For example, the confidence factor closer to zero may mean the text conversion is likely incorrect whereas the confidence factor of closer to one may mean the conversion was more than likely correct. The confidence factor is compared to a threshold value, which is either statically or dynamically set. For text conversions having confidence factors below the threshold value, a visual indicator may be displayed. The visual indication may, for example, be a color, a format change, or an alert box. In addition, the threshold may be adjustable. So the user may vary an amount of review accuracy desired.

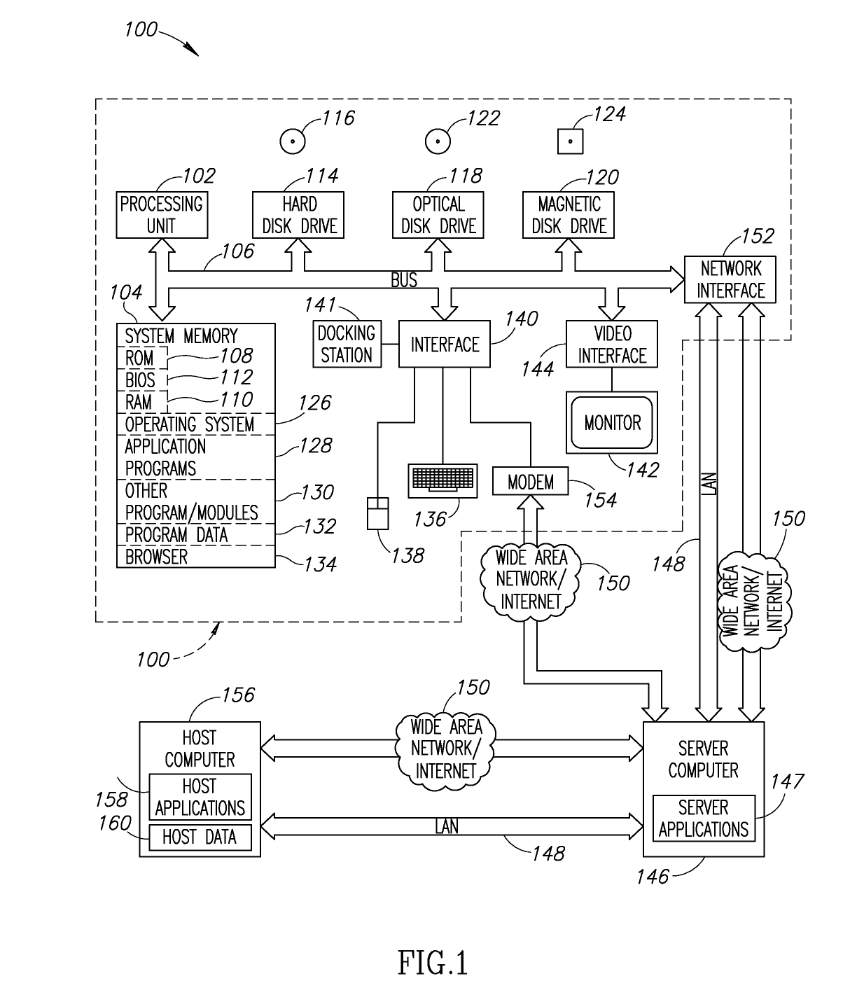

FIG. 1 in cooperation with the following provides a general description of a computing environment that may be used to implement various aspects of the present invention. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

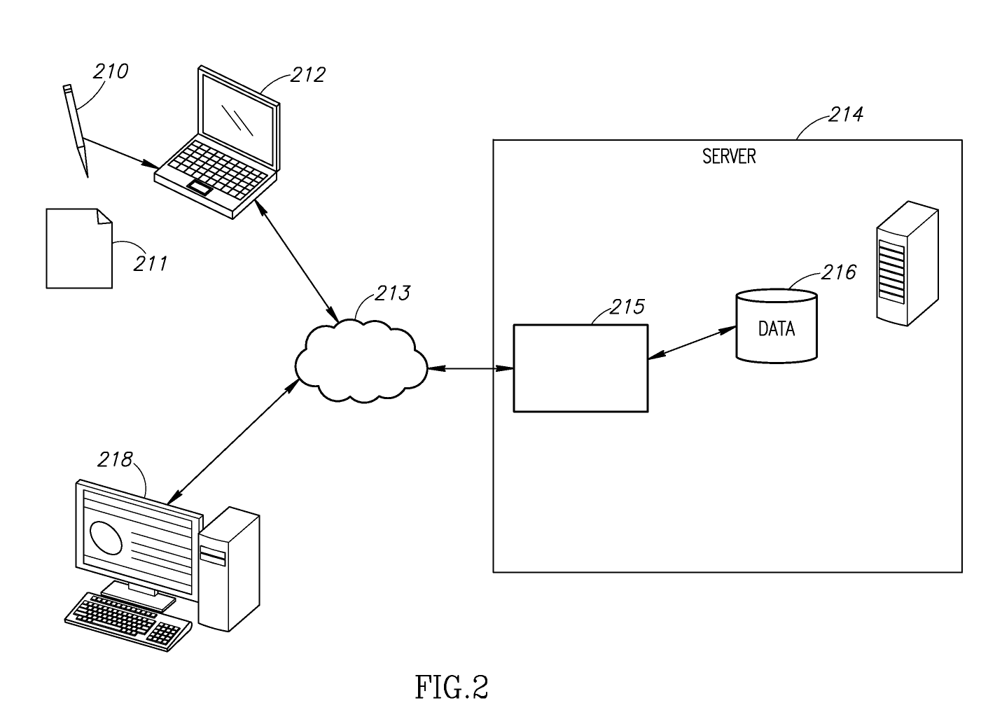

By way of example, a conventional personal computer , referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc. Unless described otherwise, the construction and operation of the various blocks shown in FIG. 2 are of conventional design. As a result, such blocks need not be described in further detail herein, as they will be understood by those skilled in the relevant art.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The system memory 104 also includes a browser 134 for permitting the computer 100 to access and exchange data with sources such as web sites of the Internet, corporate intranets, or other networks as described below, as well as other server applications on server computers such as those further discussed below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 10 as a personal computer, in other embodiments, the computer is some other computer-related device such as a personal data assistant (PDA), a cell phone, or other mobile device.

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. A monitor 142 or other display device is coupled to the bus 106 via a video interface 144, such as a video adapter. The computer 100 can include other output devices, such as speakers, printers, etc.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as business related data.

FIG. 2 is a schematic view of a system for error checking a document converted from digital ink to text according to an embodiment of the invention. A digital pen 210, is used to write on a digital document 211. The digital pen 210 stores data (i.e. digital ink) corresponding to the written text applied to the digital document 211. The digital ink is uploaded via a wired or wireless connection to a computer 212. The computer 212 transmits the digital ink through a data connection 213 to a file server 214. In an embodiment, the file server 214 is a Microsoft® SharePoint server. The server 214 stores the digital ink in a datastore 216. The server 214 includes an application 215 for text conversion of the ink as well as other features related to a file server 214. A review computer 218 is also connected to the server 214. The review computer 218 can be the same or different computer from the computer 212. The review computer 218, using the server 214, has access to the digital ink and the source document, which is defined as the document used to print the digital paper 211. The application 215 converts the digital ink into text and places the text in the correct regions of the source document. A user, using the reviewer computer 218, then reviews and approves the document for publishing. In alternate embodiments the system of FIG. 2 may also be used in conjunction with tablet computers, personal data assistants or other devices capable of converting handwritten sketches to typographical symbols.

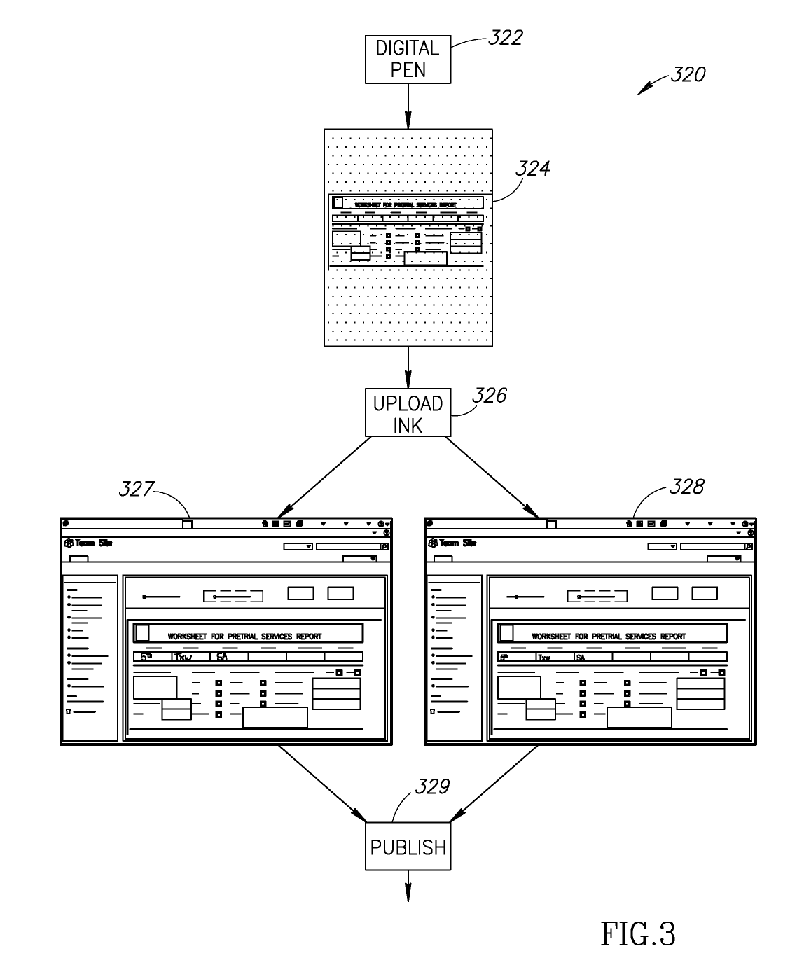

FIG. 3 shows an example of a text conversion applied to a digital document, which takes the form of a digital form. A digital pen 322 is used to fill out at least one position of a digital form 324. The form 324 contains one or more input regions, defined by a spatial area on a form, requiring a response. The form 324 is preferably designed using a spreadsheet program, the input regions defined by cells within the spreadsheet. The form 324 is printed on digital paper. The digital pen 322 is used to interact with the form 324 and stores digital ink written on the form 324. The digital ink is uploaded 326 to a computer, a network, or preferably to a central file server. The ink is then converted into text using an ink to typographical text conversion program. The converted text is placed in the text area on a digital replica of the form displayed on the file server. The text is then displayed to a user.

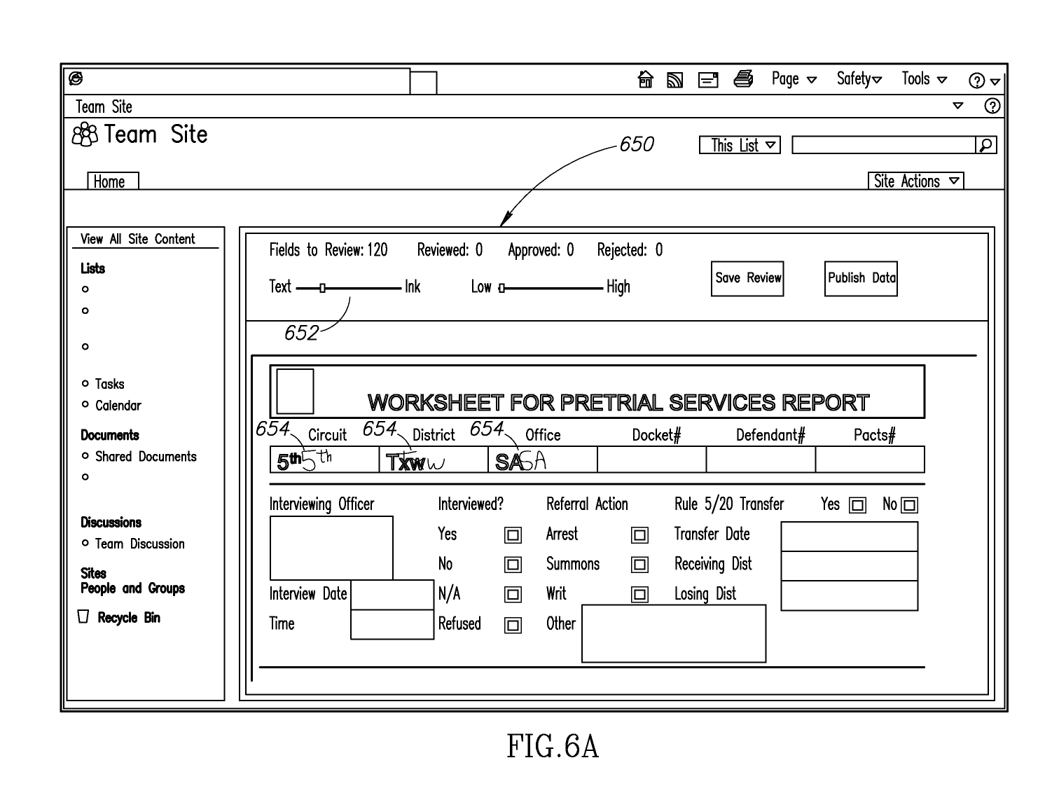

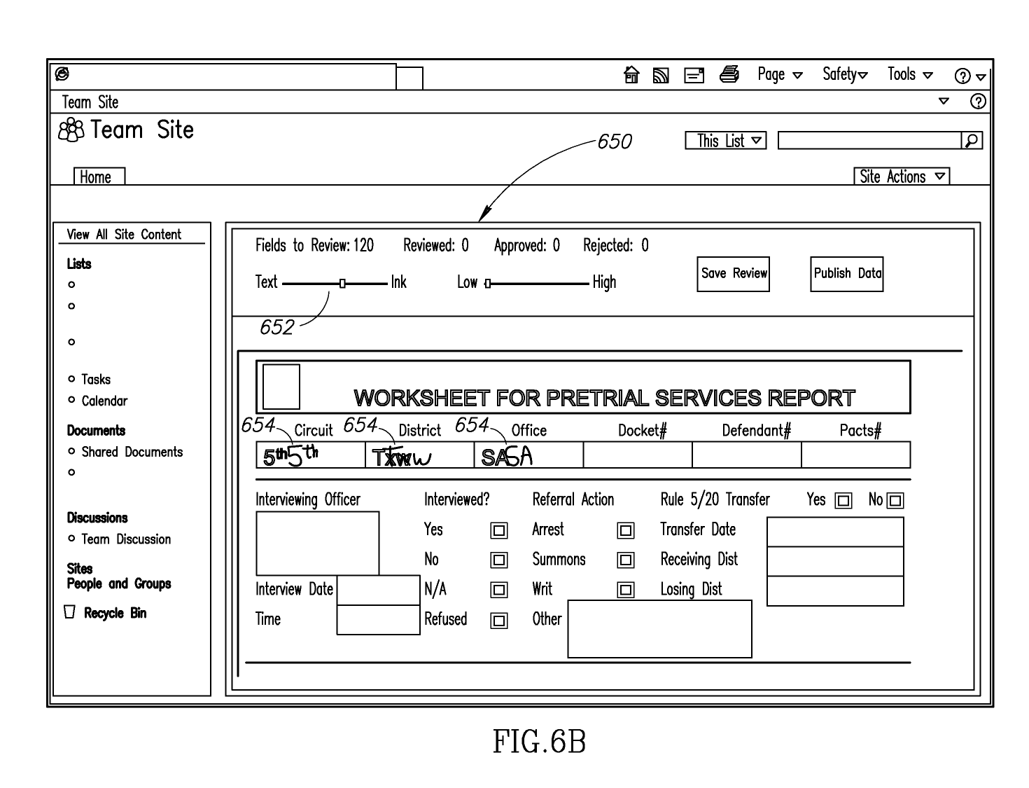

The text is displayed showing potential errors in the text conversion using an error checker 328 and/or showing ink transposed on the text 327. The error checker 328, inputs a confidence factor for each term based on the likelihood that the ink to text conversion was correct. If the confidence factor is below a particular threshold then a visual indicator is displayed on or near the text. Alternatively in display 327, the ink is overlaid on top of the converted text. The level of transparency can be selectively altered as shown in FIGS. 6A and 6B. By way of example this allows a user to see, in context, the ink and text together and then allows a user to determine whether the conversion was indeed correct. In order to determine if the text conversion was correct, the user may use display 327 and display 328 either combined or separately to review and publish 329 the form 324.

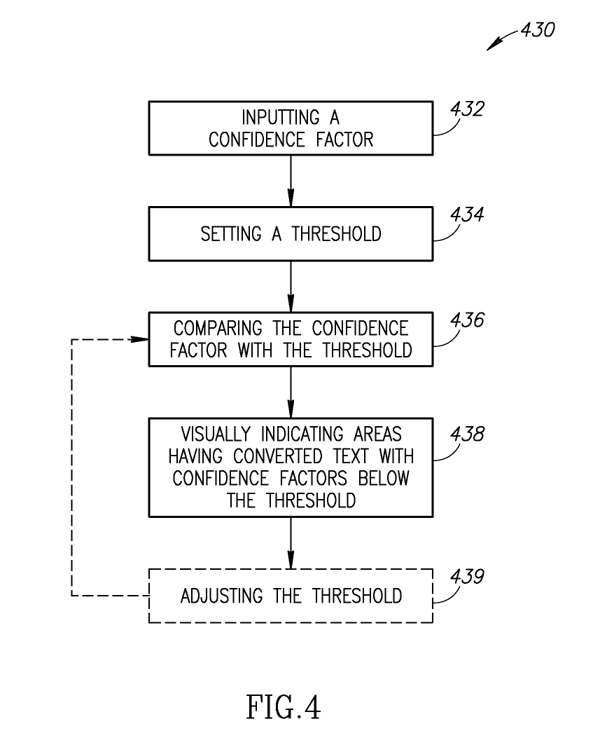

FIG. 4 is a flowchart showing a method for error checking a document converted from digital ink to text according to an embodiment of the present invention. At block 432 a series of confidence factors are input from a text conversion program that converts digital ink into typographical text. The confidence factors are determined based on the conversion of digital ink into text and the likelihood that the correct text was determined based on the digital ink. At block 434, a threshold value is set. The threshold value is a level determined based on the level of error a user is willing to accept. The threshold determines which text will be flagged. By way of example, the confidence threshold could be set at a value equal to a 60% chance the text conversion was correct and therefore then flagging any confidence factor with a value below 60%. At block 436, the confidence factors input at block 432 are analyzed and those confidence factors below the threshold are flagged. At block 438, the flagged terms are displayed visually to the user. The visual display could include format changes, color, highlight or some other available visual signal. At block 439 the threshold may be adjusted.

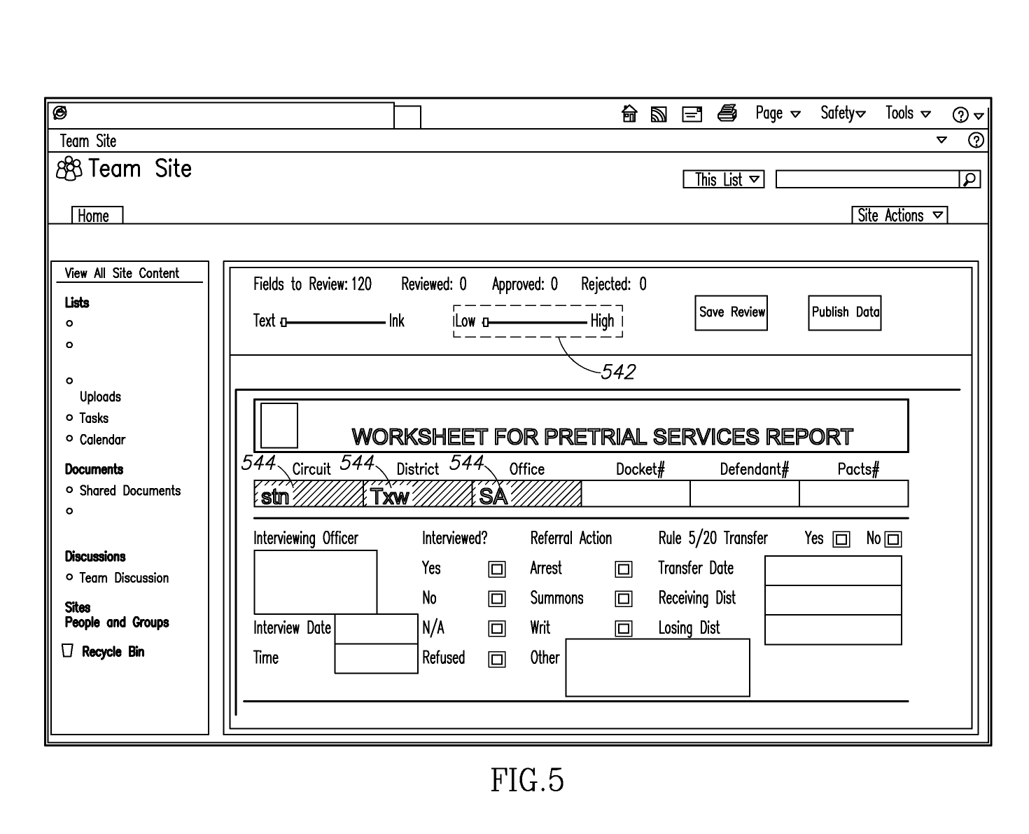

FIG. 5 is a top plan view of a form showing error checking according to an embodiment of the present invention. Shown in FIG. 5 is a form 540 having input regions 544 and an error threshold slider 542. The error threshold slider 542 sets the threshold value. As described above, each text area 544 has a confidence factor assigned based on the digital ink to typographical text conversion. The form 540 highlights the input regions 544 when the input regions confidence factor is below the threshold value of the error slider 542.

FIGS. 6A and 6B is a top plan view of a form showing error checking of a digital document by contextually comparing handwritten digital ink with typographical text according to an embodiment of the present invention. Shown in FIGS. 6A and 6B is a form 650 having a digital slider mechanism 652 and a series of input regions 654. The digital slider mechanism 652 acts to make either handwritten ink or typographical ink more visually prominent while simultaneously making the other less visually prominent. As can be seen in FIG. 6A the text is more prominent in text area 654 and in FIG. 6B the ink is more prominent in text area 654.

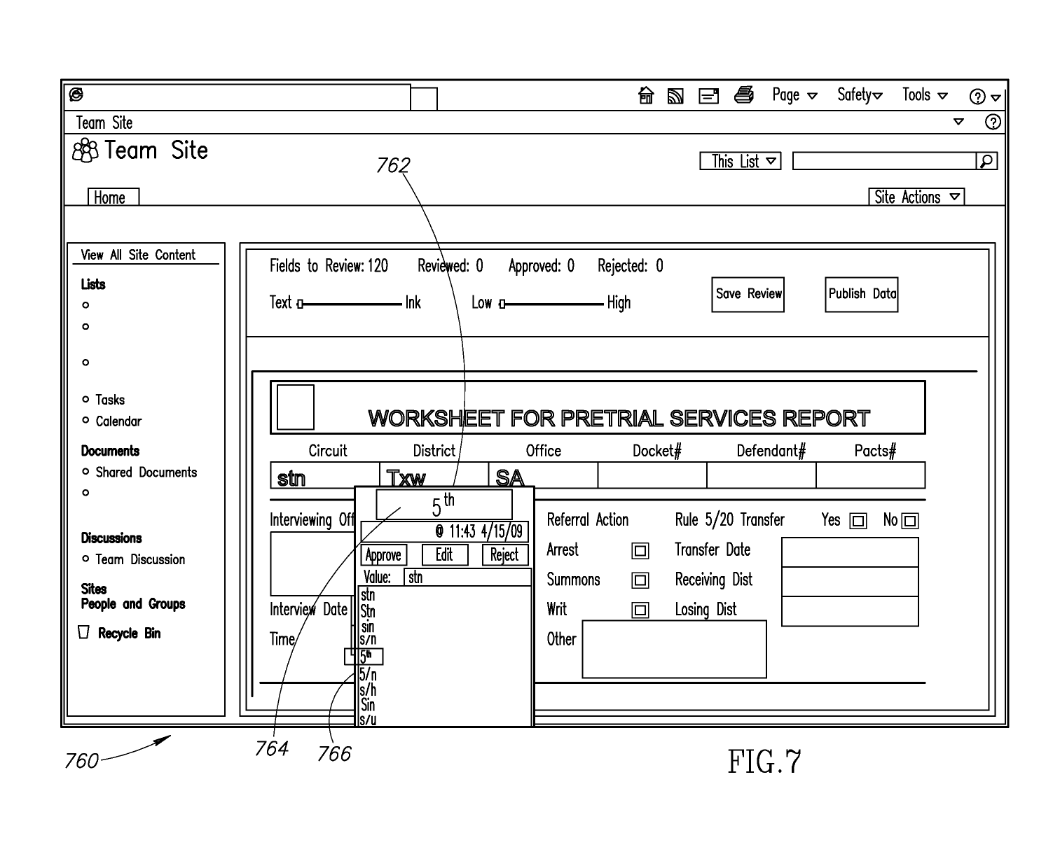

FIG. 7 is a top plan view of a form showing display interpretation options 766 for the handwritten ink 764 in a menu operably coupled to an input region 762. As shown in FIG. 7, ink is automatically converted into text in input area 762. A user then may select box 762 to correct a potential error. When the user selects box 762, a menu is shown having the original handwritten ink 764 and display interpretation options 766. The user then may select an alternate option from the interpretations option 766 to correct the text conversion.

A further embodiment of the current invention further includes the storage of forms as a portable document format. Forms can be rendered as a portable document format document that incorporates the full set of metadata, stored as layers related to the digital ink and its textual interpretations. Information about the author associated with the digital pen used to fill out the form, date/time each field was been filled out with a digital pen, as well as detailed ink stroke information and its textual interpretation are represented in portable document format documents as native annotations. All annotations are preferably locked so that they cannot be deleted or modified by users. These annotations therefore represent the content of the corresponding handwritten annotations and sketching performed on the paper printout that corresponds to the electronic rendition.

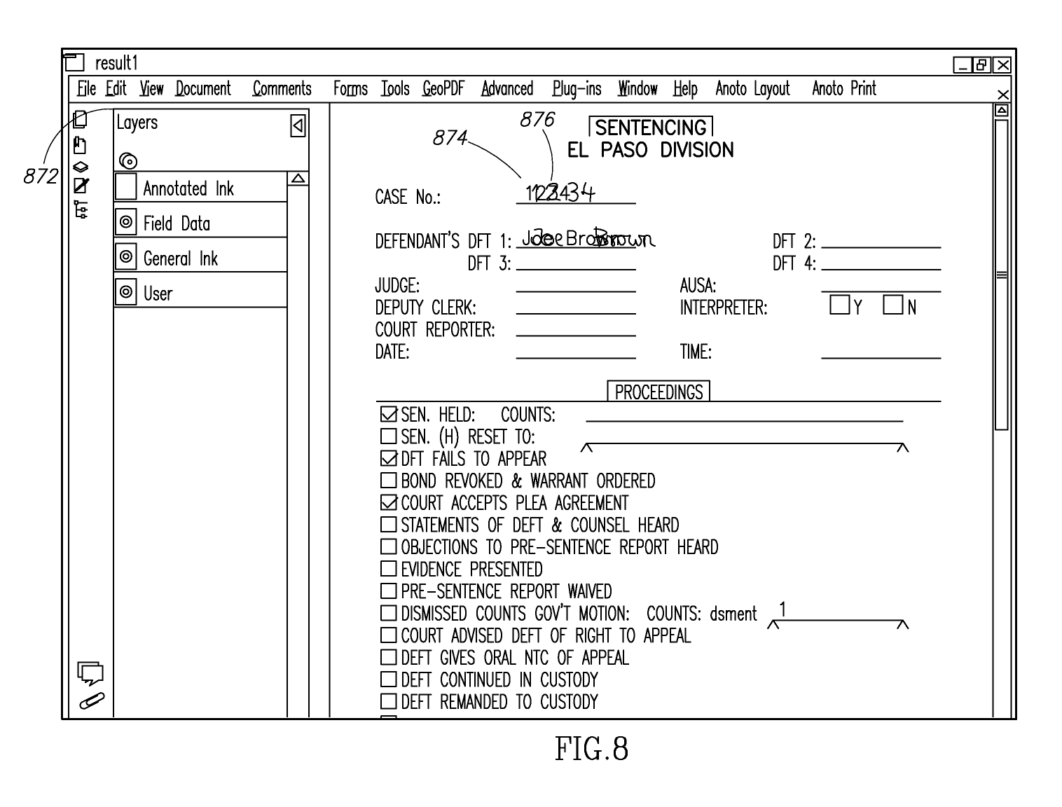

FIG. 8 is a top plan view of a form having both ink and text stored in the portable document format. The information is organized around portable document format layers 872, which permit users to control which aspects are displayed. These layers 872 include for example: (1) A layer named after the Author (as identified in the digital pen) of the digital ink. This layer turns on/off all the information that has been filled out by specific users. (2) A layer that controls the display of all the digital ink 874 in a page (the General Ink), including marginalia and ink that is applied outside of the form fields (which are not automatically interpreted). (3) A layer that controls the display of all the textual interpretation 876 automatically generated by the system, representing the handwriting recognition of the corresponding field ink. (4) An Annotated Ink layer, which controls the display of digital ink to which the textual interpretations are associated. This association permits users to hover over a field with a pointing device and see the author of the ink and the automatically generated textual interpretation of the ink. In other variations the date/time information is displayed in the popup box. Most layers can be activated independently, so that a rendition that includes both textual data and the ink can be displayed.

An additional view of the metadata can be activated by right-clicking on an annotation and selecting to view its Properties. The information displayed is for example the author, name of the field in the original form template (in the Subject Field), as well as the modified date showing when this field was last inked on.

Ink annotation further contains a detailed set of coordinates organized as sets of strokes that represent the coordinates traced by the digital pen by the user as she filled out the paper form. The relative coordinates of the paper are automatically converted into equivalent matching coordinates in the native portable document format coordinate system. The result is that the electronic rendition displays the electronic ink within a position that is less than 0.2 mm away from the corresponding position of the actual ink on the paper printout that got filled out with the digital pen.

Alternative ink interpretation hypotheses are stored, along their respective recognition levels of confidence as custom metadata embedded in each textual annotation field. While this extra information may or may not be visible to users via a portable document format viewer user interface.

In an embodiment, the interpreted textual data is presented within form fields, rather than as textual annotations. In this case, the alternative ink interpretation hypotheses may be presented for instance within a dropdown list from which users can pick an alternate interpretation. Picking an interpretation may take place by directly selection of the element on the list, or by predictive completion. If the intended value of a field is not present in the list, users may then type in the new value.

Form instances that have been populated with data prior to printing are represented in a portable document format document as portable document format elements such as textual annotations that are always displayed, independently of the state of the layers.

Such pre-populated data is displayed as if it were part of the underlying background image of the form. Fields containing pre-populated data is protected from user input. If a user inks over one of the pre-populated fields, the value of the field does not change. The ink is displayed as if it were part of the General Ink.

When users write with a digital pen on the same form that has already been uploaded to a system and rendered as a portable document format, this causes the ink from previous uploads to be displayed “dimmed out”. The older the ink (according to its ink upload history), the more dimmed it displays. Ink corresponding to the most recent upload is not dimmed. This permits users to determine at a glance how old each patch of digital ink is, and be able to identify the most recent one.

To support ink upload on disconnected computers, portable document format documents representing the background images of forms are stored locally e.g. during form printing in a portable document format background cache. On a local disconnected upload, the ink may be rendered on a copy of the portable document format background that corresponds to the paper form the user inked on. Users may then use local portable document format viewers to visualize the ink, and depending on the device, examine and correct the textual interpretations generated locally. A portable document format document containing the ink meta-data and optionally the textual interpretation may then be imported into a SharePoint (or other form repository). The import operation extracts the identity of the form, the digital ink and optionally the textual interpretations, and creates a corresponding electronic form in the system into which it is being imported.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method for reviewing digital pen data retrieved from a digital pen, the method comprising:
interpreting the digital pen data to produce a typographical symbol;
placing the digital pen data and the typographical symbol in an input region of a display device, wherein the digital pen data includes at least one handwritten mark made with the digital pen; and
changing a view of the digital pen data relative to the typographical symbol, wherein changing the view includes making one of the data or the symbol more viewably prominent while simultaneously making the other less viewably prominent.

2. The method of claim 1 further comprising assigning a confidence factor to the typographical symbol.

3. The method of claim 2 further comprising:
assigning a threshold value; and
highlighting the input region when the confidence factor is below the assigned threshold value.

4. The method of claim 1 wherein placing the digital pen data and the typographical symbol includes overlaying the typographical symbol onto the data in the input region.

5. The method of claim 1 wherein placing the digital pen data and the typographical symbol includes arranging the typographical symbol next to the digital pen data in the input region.

6. The method of claim 1 wherein changing the view includes selectively altering the view by moving at least one digital slider mechanism.

7. The method of claim 1 wherein making one of the data or the symbol less viewably prominent includes making one of the data or the symbol transparent.

8. The method of claim 1 wherein changing the view includes selectively contrasting one of the data or the symbol with the other.

9. The method of claim 1 wherein producing the typographical symbol includes producing at least one alphanumeric character.

10. The method of claim 1 further comprising displaying interpretation options for the data in a menu operably coupled to the input region.

11. A method for checking a conversion of digital pen data to typographical text, implemented on at least one computer, the method comprising:
acquiring a confidence factor from a text conversion program, the confidence factor generated based on likelihood of correctness for the conversion;
assigning a threshold value;
comparing the confidence factor to the assigned threshold value; and
displaying visually all conversions having a confidence factor below the threshold value.

12. The method of claim 11 further comprising adjusting the threshold value.

13. The method of claim 11 wherein displaying visually includes highlighting a spatially defined area on a display device.

14. The method of claim 11 wherein displaying visually includes adjusting a format of the conversion.

15. The method of claim 11 wherein adjusting the threshold value includes selectively altering the threshold value using at least one digital slider mechanism.
